(19) United States
(12) Patent Application Publication
(10) Pub. No.: US 2026/0142711 A1
(43) Pub. Date: May 21, 2026

(54) METHODS AND APPARATUSES FOR BEAM REFERENCE SIGNAL RECEIVED POWER RATE OF CHANGE COMMUNICATION

(71) Applicant: Huawei Technologies Co., Ltd., Shenzhen (CN)

(72) Inventors: Mostafa Medra, Ottawa (CA); Mohammadhadi Baligh, Ottawa (CA); Xi Zhang, Beijing (CN)

(21) Appl. No.: 19/434,976

(22) Filed: Dec. 29, 2025

Related U.S. Application Data
(63) Continuation of application No. PCT/CN2023/105171, filed on Jun. 30, 2023.

(51) Int. Cl. H04B 7/06

(52) U.S. Cl. CPC H04B 7/06952

(57) ABSTRACT

Aspects of the present disclosure may provide methods, apparatuses and devices for enabling a first device to send configuration information to a be received by a second device. The configuration information including one or more parameter associated with a rate of change of received power of a reference signal (RSRP) transmitted over a beam, wherein the rate of change indicates a change of the received power in at least one of a specific direction, one or more directions, or per time slot. In some embodiments, the first device may be a network side device and the second device may be a terminal side device. In some embodiments, the first device may be a terminal side device and the second device may be a network side device. A network side device may be a base station and a terminal side device may be a UE.

### CROSS REFERENCE

This application is a continuation of International Application PCT/CN2023/105171, filed on Jun. 30, 2023, the disclosure of which is hereby incorporated by reference in its entirety.

### TECHNICAL FIELD

The present disclosure relates generally to wireless communications, and in particular to methods and apparatuses for beam reference signal received power gradient communication.

### BACKGROUND

When a device is equipped with phase shift antenna arrays, each antenna element may be attached to a phase shifter, and these phase shifters may be used for enhancing at least one of the signal-to-interference-plus-noise ratio (SINR) or reliability of communication link by shaping an output beam. By setting these phases, analog beamforming may be induced that may focus a signal in one or more specific directions and thereby increasing signal power in these directions. Such power increase results from the beamforming gain and may be more important at higher frequencies in order to combat the path losses at those frequencies. Analog beamforming may be simultaneously implemented at both the transmitter and the receiver, including a base station (BS) and a user equipment (UE) in a wireless access system. The set of phases for the phase shifters that directs the signal to a certain angle or direction may be called an analog beamformer and a set of analog beamformers may be grouped into a codebook. One common codebook for covering the angular domain for uniform linear array (ULA) antenna arrays is a discrete Fourier transform (DFT) matrix, where each column is a beamformer that points in a certain direction, and the number of rows of that matrix is the number of antennas at the device. A 2D DFT codebook may be used for a uniform planar array (UPA).

In beam-based communications, beam quality is monitored by using one or more metrics, e.g., signal-to-noise ratio (SNR), SINR, reference signal received quality (RSRQ), and signal power. In one scenario, the UE does frequent measurements and obtains the beam reference signal received power (RSRP) and periodically reports that RSRP to the BS for various beam management procedures. The UE may also report the beam RSRP for more than one beam. The measured beam RSRP depends on various factors, some of which are constant, and others which may change over time. For example, the beam RSRP may depend on one or more of the BS beams, the antenna pattern for each antenna element at the BS, the antenna panel tilt, phase shifters accuracy, and radio frequency (RF) chain. In addition to similar factors at the UE, the UE may also move or change orientation. In some systems such as non-terrestrial networks, the BS may also be subject to movement and rotation. Furthermore, the channel may change from time to time and from place to place. Given the large number of factors that can affect the beam RSRP, continuous measurement and reporting may be used to maintain a reliable link and thus, may result in a large overhead specially for high mobility UEs.

When the UE reports the beam RSRP for one or more beams, as instructed by the BS, these reported values may affect different beam procedures. The BS may instruct the UE to do a beam switching procedure when the BS detects that a beam, other than the serving beam, may be a better beam for communication with that UE. In addition, the BS may instruct the UE of one or more beams, other than the serving beam, that the UE may use for possible beam failure recovery when the serving beam fails, i.e., when the received signal power is not enough for proper decoding of the transmitted data and/or control signals. The UE may even measure and report beams from other BSs for possible handover.

### SUMMARY

According to beam shape and width and UE movement, the gradient of received power of a reference signal transmitted over a given beam direction per time slot may vary over time and space. The variation of the RSRP may require large overhead of measuring and feedback for proper tracking for various beam management procedures.

In current systems, how the RSRP may vary is not being informed to the UE. Therefore, the UE measurements are independent from the beam shape and width resulting in many measurements and feedback needed for beam procedures.

Aspects of the disclosure provide communication between the BS and UE regarding the expected gradient of received power of a reference signal transmitted over one beam in a certain direction per time slot, i.e., how the beam RSRP may change in that direction. BS configuration of the UE is also proposed regarding how to use the RSRP gradient information for a beam in various beam management methods. When the UE obtains the RSRP gradient information for a beam from the BS, the UE becomes aware of the expected beam RSRP gradient for that direction, and compares that expected value to the measured values. According to how aligned the expected and measured values are, the UE may efficiently perform various beam management methods.

According to some aspects of the disclosure, there is provided a method including; receiving, by an apparatus, configuration information, the configuration information including one or more parameter associated with a rate of change of received power of a reference signal transmitted over a beam, wherein the rate of change indicates the change of the received power in at least one of: a specific direction; one or more directions; or per time slot.

In some embodiments, the rate of change of received power of a reference signal transmitted over one beam direction is rate of change information for at least one of: a direction normal to the beam angular direction in an orientation parallel to the surface of the Earth; a direction along the beam angular direction; or a direction normal to the beam angular direction in an orientation perpendicular to the surface of the Earth.

In some embodiments, when the one or more parameter associated with the rate of change of the received power of a reference signal over one beam direction is provided in any of a plurality of different forms, the method further including receiving an indication of the form of the plurality of different forms that is used to provide information regarding the rate of change of the received power of a reference signal transmitted over one beam direction.

In some embodiments, when the one or more directions are at least two directions, the configuration information is received with at least one of different periodicity, different granularity or different dynamic range for at least two directions of the at least two directions.

In some embodiments, the one or more parameter includes at least one of: rate of change of the received power of a reference signal information expressed in terms of distance from a reference location; or rate of change of the received power of a reference signal information expressed in terms of time from a reference time.

In some embodiments, the rate of change of the received power of a reference signal expressed in terms of distance is expressed in terms of: a distance over which the beam received power of a reference signal drops by a certain value; a slope of the beam received power of a reference signal rate of change along a certain service distance; an approximation of the beam received power of a reference signal rate of change determined using higher order polynomials; a distance to a first null, where a null is defined by a large loss; or a distance for which a metric drops by an amount defined in a threshold value.

In some embodiments, the one or more parameter associated with the rate of change of the received power of a reference signal is for each of one or more beam.

In some embodiments, the one or more beam includes one or more of: a communication beam; one or more beam that may potentially be used for beam switching; one or more beam that may potentially be used for beam failure recovery; or one or more beam that may potentially be used for handover.

In some embodiments, the configuration information is received: periodically; after the configuration information is updated; or after the apparatus requests updated configuration information.

In some embodiments, the method further including receiving an indication regarding how rate of change of the received power of a reference signal information associated with a previous beam may be used to determine a new rate of change of the received power of a reference signal.

In some embodiments, the method further including transmitting capability information of the apparatus.

In some embodiments, the apparatus capability information includes at least one of: whether the apparatus includes access to at least one of: a compass; a gyroscope; an accelerometer; or other types of sensors; or an indication of at least one of precision or accuracy of coordinate measurement.

In some embodiments, the method further including receiving configuration information associated with using rate of change of the received power of a reference signal including parameters that are used for beam management functions including at least one of: beam measurement and reporting; beam switching; beam failure detection; or beam failure recovery.

In some embodiments, the configuration information includes information to configure the apparatus regarding at least one of: frequency of measuring and reporting feedback information related to the rate of change of the received power of a reference signal transmitted over one beam direction; report feedback in a differential form by comparing the expected beam received power of a reference signal and measured beam received power of a reference signal; estimate the beam received power of a reference signal using the received parameters and UE measurements; how and when to initiate apparatus beam refinement based on the received parameters and measured beam received power of a reference signal; how and upon which criteria to start apparatus-initiated beam switching based on the received parameters and measured beam received power of a reference signal; how to use the received parameters associated with the rate of change of received power of a reference signal and measured beam received power of a reference signal to assess beams during a beam failure recovery; or how to use parameters associated with the rate of change of the received power of a reference signal transmitted over one beam direction of different beams to determine a beam for possible beam failure recovery and associated uplink (UL) transmit power for the determined beam.

In some embodiments, the method further including measuring beam received power of a reference signal; and reporting feedback in a differential form by comparing the expected beam received power of a reference signal and measured beam received power of a reference signal.

In some embodiments, the method further including: measuring beam received power of a reference signal; estimating beam received power of a reference signal based on the configuration information, previous beam received power of a reference signal measurements, and location of the apparatus; comparing the estimated and measured beam received power of a reference signal; when the compared estimated and measured beam received power of a reference signal meet a configured condition for beam switching, transmitting a message to start initiating beam switching.

In some embodiments, the method further including: measuring beam received power of a reference signal; estimating beam received power of a reference signal based on the configuration information, previous beam received power of a reference signal measurements, and location of the apparatus; comparing the estimated and measured beam received power of a reference signal; when the compared estimated and measured beam received power of a reference signal meet a configured condition indicating a potential beam failure detected event, selecting one or more beams based on beam received power of a reference signal rate of change information for other beams to be used for beam failure recovery. determining UL transmit power for the other beams to be used for beam failure recovery.

In some embodiments, the method further including: measuring beam received power of a reference signal; estimating beam received power of a reference signal based on the configuration information, previous beam received power of a reference signal measurements, and location of the apparatus; comparing the estimated and measured beam received power of a reference signal; when the compared estimated and measured beam received power of a reference signal are less than a configured condition, initiate an apparatus side beam refinement.

In some embodiments, the method further including transmitting feedback information based on the rate of change of received power of a reference signal transmitted over one beam direction and measured received power of a reference signal of the same beam.

According to some aspects of the disclosure, there is provided an apparatus including one or more processor configured to: receive configuration information, the configuration information including one or more parameter associated with a rate of change of received power of a reference signal transmitted over a beam, wherein the rate of change indicates the change of the received power in at least one of: a specific direction; one or more directions; or per time slot.

According to some aspects of the disclosure, there is provided an apparatus including one or more processor; a non-transitory computer-readable memory having stored thereon processor executable instructions, that when executed by the one or more processors, cause the apparatus to: receive configuration information, the configuration information including one or more parameter associated with a rate of change of received power of a reference signal transmitted over a beam, wherein the rate of change indicates the change of the received power in at least one of: a specific direction; one or more directions; or per time slot.

According to some aspects of the disclosure, there is provided a method involving transmitting, by an apparatus, configuration information, the configuration information including one or more parameter associated with a rate of change of received power of a reference signal transmitted over a beam, wherein the rate of change indicates the change of the received power in at least one of: a specific direction; one or more directions; or per time slot.

In some embodiments, the rate of change of the received power of a reference signal transmitted over one beam direction is rate of change information for at least one of: a direction normal to the beam angular direction in an orientation parallel to the surface of the Earth; a direction along the beam angular direction; or a direction normal to the beam angular direction in an orientation perpendicular to the surface of the Earth.

In some embodiments, when the one or more parameter associated with the rate of change of the received power of a reference signal over one beam direction is provided in any of a plurality of different forms, the method further including transmitting an indication of the form of the plurality of different forms that is used to provide information regarding the rate of change of the received power of a reference signal transmitted over one beam direction.

In some embodiments, when the one or more directions are at least two directions, the configuration information is transmitted with at least one of different periodicity, different granularity or different dynamic range for at least two directions of the at least two directions.

In some embodiments, the one or more parameter includes at least one of: rate of change of the received power of a reference signal information expressed in terms of distance from a location of a transmitter of the reference signal; or rate of change of the received power of a reference signal information expressed in terms of time from transmission of a location of a transmitter of the reference signal.

In some embodiments, the rate of change of the received power of a reference signal expressed in terms of distance is expressed in terms of: a distance over which the beam RSRP drops by a certain value; a slope of the beam the received power of a reference signal rate of change along a certain service distance; an approximation of the beam received power of a reference signal rate of change determined using higher order polynomials; a distance to a first null, where a null is defined by a large loss; or a distance for which a metric drops by an amount defined in a threshold value.

In some embodiments, the one or more parameter associated with the rate of change of the received power of a reference signal is for each of one or more beam.

In some embodiments, the one or more beam includes one or more of: a communication beam; one or more beam that may potentially be used for beam switching; one or more beam that may potentially be used for beam failure recovery; or one or more beam that may potentially be used for handover.

In some embodiments, the configuration information is received: periodically; after the configuration information is updated; or after a wireless communication device requests updated configuration information.

In some embodiments, the method further including transmitting an indication regarding how rate of change of the received power of a reference signal information associated with a previous beam may be used to determine a new rate of change of the received power of a reference signal.

In some embodiments, the method further including receiving capability information of a wireless communication device.

In some embodiments, the wireless communication device capability information includes at least one of: whether the wireless communication device includes access to at least one of: a compass; a gyroscope; an accelerometer; or other types of sensors; or an indication of at least one of precision or accuracy of coordinate measurement.

In some embodiments, the method further including receiving configuration information associated with using rate of change of the received power of a reference signal including parameters that are used for beam management functions including at least one of: beam switching; beam failure detection; or beam failure recovery.

In some embodiments, the configuration information includes information to configure a wireless communication device regarding at least one of: frequency of measuring and reporting feedback information related to the rate of change of the received power of a reference signal over one beam direction; report feedback in a differential form by comparing the expected beam received power of a reference signal and measured beam received power of a reference signal; estimate the beam received power of a reference signal using the received parameters and UE measurements; how and when to initiate wireless communication device beam refinement based on the received parameters and measured beam received power of a reference signal; how and upon which criteria to start wireless communication device-initiated beam switching based on the received parameters and measured beam received power of a reference signal; how to use the received parameters associated with the rate of change of the received power of a reference signal and measured beam received power of a reference signal to assess beams during a beam failure recovery; or how to use parameters associated with the rate of change of the received power of a reference signal transmitted over one beam direction of different beams to determine a beam for possible beam failure recovery and associated uplink (UL) transmit power for the determined beam.

In some embodiments, the method further including receiving feedback information based on the rate of change of the received power of the reference signal transmitted over one beam direction and measured received power of a reference signal of a same beam direction.

In some embodiments, the method further including receiving a message to initiate beam switching.

In some embodiments, the method further including receiving random access channel (RACH) from apparatus side device for beam failure recovery.

According to some aspects of the disclosure, there is provided an apparatus including one or more processor configured to: transmit configuration information, the configuration information including one or more parameter associated with a rate of change of received power of a reference signal transmitted over a beam, wherein the rate of change indicates the change of the received power in at least one of: a specific direction; one or more directions; or per time slot.

According to some aspects of the disclosure, there is provided an apparatus including one or more processor; a non-transitory computer-readable memory having stored thereon processor executable instructions, that when executed by the one or more processors, cause the apparatus to: transmit configuration information, the configuration information including one or more parameter associated with a rate of change of received power of a reference signal transmitted over a beam, wherein the rate of change indicates the change of the received power in at least one of: a specific direction; one or more directions; or per time slot.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 is a schematic diagram of a communication system in which embodiments of the present disclosure may occur.

FIG. 2 is another schematic diagram of a communication system in which embodiments of the present disclosure may occur.

FIG. 3 is a block diagram illustrating units or modules in a device in which embodiments of the present disclosure may occur.

FIG. 4 is a block diagram illustrating units or modules in a device in which embodiments of the present disclosure may occur.

FIG. 5 is a schematic diagram illustrating a transmission of a main beam with side lobes by a base station in a beam direction towards a user equipment (UE) and also showing how beam RSRP gradient information may be provided for multiple directions according to aspects of the present disclosure.

FIGS. 6A, 6B, 6C and 6D are graphical plots showing simulated RSRP versus distance between a BS and a UE for different beam directions.

FIG. 7 illustrates a signal flow diagram for signaling between a base station and a UE illustrating an example process for supporting network communication, in accordance with embodiments of the present disclosure.

FIG. 8 illustrates another signal flow diagram for signaling between a base station and a UE illustrating an example process for supporting network communication, in accordance with embodiments of the present disclosure.

### DETAILED DESCRIPTION

For illustrative purposes, specific example embodiments will now be explained in greater detail below in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e., DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

Aspects of the present disclosure may provide methods, apparatuses and devices for enabling a first device to send configuration information to a be received by a second device. The configuration information including one or more parameter associated with a rate of change of received power of a reference signal (RSRP) transmitted over a beam, wherein the rate of change indicates a change of the received power in at least one of a specific direction, one or more directions, or per time slot. In some embodiments, the first device may be a base station, or more generally a network side device, and the second device may be a UE, or more generally a terminal side device. In some embodiments, the first device may be a UE, or more generally a terminal side device, and the second device may be a base station, or more generally a network side device. In some embodiments, the first device and the second device may both be a UE, or more generally a terminal side device.

In some embodiments, the first device may send for receipt by the second device configuration information associated with using beam RSRP rate of change or gradient information including parameters that are used for beam management functions including at least one of: beam measurement and reporting; beam switching; beam failure detection; or beam failure recovery.

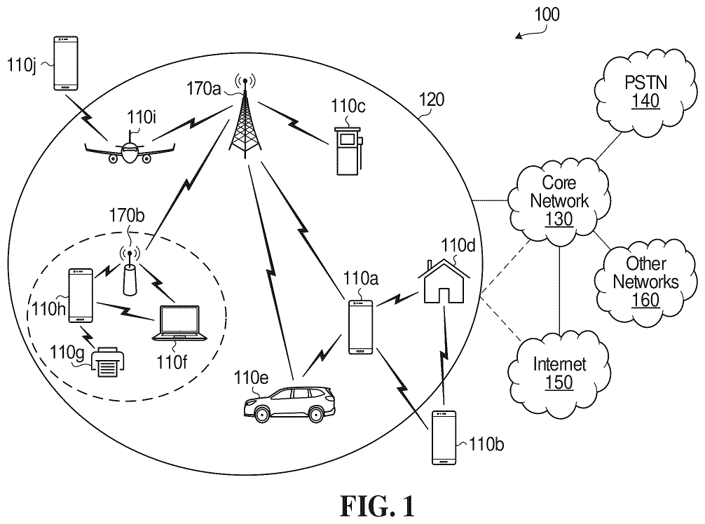

FIGS. 1, 2, and 3 following below provide context for the network and device that may be in the network and that may implement aspects of the present disclosure.

Referring to FIG. 1, as an illustrative example without limitation, a simplified schematic illustration of a communication system is provided. The communication system 100 comprises a radio access network 120. The radio access network 120 may be a next generation (e.g., sixth generation (6G) or later) radio access network, or a legacy (e.g., 5G, 4G, 3G or 2G) radio access network. One or more communication electric device (ED) 110a-120j (generically referred to as 110) may be interconnected to one another, and may also or instead be connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

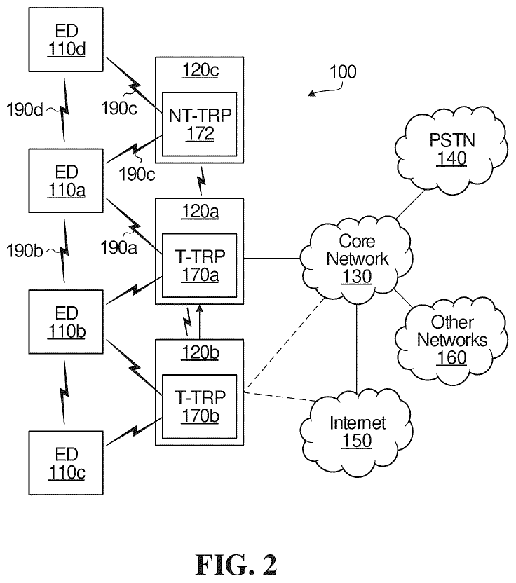

FIG. 2 illustrates an example communication system 100 in which embodiments of the present disclosure could be implemented. In general, the system 100 enables multiple wireless or wired elements to communicate data and other content. The purpose of the system 100 may be to provide content (voice, data, video, text) via broadcast, narrowcast, user device to user device, etc. The system 100 may operate efficiently by sharing resources such as bandwidth.

In this example, the communication system 100 includes electronic devices (ED) 110a-110c, radio access networks (RANs) 120a-120b, a core network 130, a PSTN 140, the Internet 150, and other networks 160. While certain numbers of these components or elements are shown in FIG. 2, any reasonable number of these components or elements may be included in the system 100.

The EDs 110a-110c are configured to operate, communicate, or both, in the system 100. For example, the EDs 110a-110c are configured to transmit, receive, or both via wireless communication channels. Each ED 110a-110c represents any suitable end user device for wireless operation and may include such devices (or may be referred to) as a user equipment/device (UE), wireless transmit/receive unit (WTRU), mobile station, mobile subscriber unit, cellular telephone, station (STA), machine type communication device (MTC), personal digital assistant (PDA), smartphone, laptop, computer, touchpad, wireless sensor, terminal side device, or consumer electronics device.

FIG. 2 illustrates an example communication system 100 in which embodiments of the present disclosure could be implemented. In general, the communication system 100 enables multiple wireless or wired elements to communicate data and other content. The purpose of the communication system 100 may be to provide content (voice, data, video, text) via broadcast, multicast, unicast, user device to user device, etc. The communication system 100 may operate by sharing resources such as bandwidth.

In this example, the communication system 100 includes electronic devices (ED) 110a-110d, radio access networks (RANs) 120a-120c, a core network 130, a public switched telephone network (PSTN) 140, the internet 150, and other networks 160. Although certain numbers of these components or elements are shown in FIG. 2, any reasonable number of these components or elements may be included in the communication system 100.

The EDs 110a-110d are configured to operate, communicate, or both, in the communication system 100. For example, the EDs 110a-110d are configured to transmit, receive, or both, via wireless or wired communication channels. Each ED 110a-110d represents any suitable end user device for wireless operation and may include such devices (or may be referred to) as a UE, WTRU, mobile station, fixed or mobile subscriber unit, cellular telephone, STA, MTC device, PDA, smartphone, laptop, computer, tablet, wireless sensor, or consumer electronics device.

In FIG. 2, the RANs 120a-120b include base stations 170a-170b, respectively. Each base station 170a-170b is configured to wirelessly interface with one or more of the EDs 110a-110c to enable access to any other base station 170a-170b, the core network 130, the PSTN 140, the internet 150, and/or the other networks 160. For example, the base stations 170a-170b may include (or be) one or more of several well-known devices, such as a base transceiver station (BTS), a Node-B (NodeB), an evolved NodeB (eNodeB), a Home eNodeB, a gNodeB, a transmission and receive point (TRP), a site controller, an access point (AP), or a wireless router.

In some examples, one or more of the base stations 170a-170b may be a terrestrial base station that is attached to the ground. For example, a terrestrial base station could be mounted on a building or tower. Alternatively, one or more of the base stations 172 may be a non-terrestrial base station, or non-terrestrial TRP (NT-TRP), that is not attached to the ground. A flying base station is an example of the non-terrestrial base station. A flying base station may be implemented using communication equipment supported or carried by a flying device. Non-limiting examples of flying devices include airborne platforms (such as a blimp or an airship, for example), balloons, quadcopters and other aerial vehicles. In some implementations, a flying base station may be supported or carried by an unmanned aerial system (UAS) or an unmanned aerial vehicle (UAV), such as a drone or a quadcopter. A flying base station may be a moveable or mobile base station that can be flexibly deployed in different locations to meet network demand. A satellite base station is another example of a non-terrestrial base station. A satellite base station may be implemented using communication equipment supported or carried by a satellite. A satellite base station may also be referred to as an orbiting base station.

Any ED 110a-110d may be alternatively or additionally configured to interface, access, or communicate with any other base station 170a-170b, the internet 150, the core network 130, the PSTN 140, the other networks 160, or any combination of the preceding.

The EDs 110a-110d and base stations 170a-170b, 172 are examples of communication equipment that can be configured to implement some or all of the operations and/or embodiments described herein. In the embodiment shown in FIG. 2, the base station 170a forms part of the RAN 120a, which may include other base stations, base station controller(s) (BSC), radio network controller(s) (RNC), relay nodes, elements, and/or devices. Any base station 170a, 170b may be a single element, as shown, or multiple elements, distributed in the corresponding RAN, or otherwise. Also, the base station 170b forms part of the RAN 120b, which may include other base stations, elements, and/or devices. Each base station 170a-170b transmits and/or receives wireless signals within a particular geographic region or area, sometimes referred to as a “cell” or “coverage area”. A cell may be further divided into cell sectors, and a base station 170a-170b may, for example, employ multiple transceivers to provide service to multiple sectors. In some embodiments, there may be established pico or femto cells where the radio access technology supports such. In some embodiments, multiple transceivers could be used for each cell, for example using multiple-input multiple-output (MIMO) technology. The number of RAN 120a-120b shown is exemplary only. Any number of RAN may be contemplated when devising the communication system 100.

The base stations 170a-170b, 172 communicate with one or more of the EDs 110a-110c over one or more air interfaces 190a, 190c using wireless communication links, e.g., radio frequency (RF), microwave, infrared (IR), etc. The air interfaces 190a, 190c may utilize any suitable radio access technology. For example, the communication system 100 may implement one or more orthogonal or non-orthogonal channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a, 190c.

A base station 170a-170b,172 may implement Universal Mobile Telecommunication System (UMTS) Terrestrial Radio Access (UTRA) to establish an air interface 190a, 190c using wideband CDMA (WCDMA). In doing so, the base station 170a-170b.172 may implement protocols such as High Speed Packet Access (HSPA), Evolved HPSA (HSPA+) optionally including High Speed Downlink Packet Access (HSDPA), High Speed Packet Uplink Access (HSPUA) or both. Alternatively, a base station 170a-170b,172 may establish an air interface 190a,190c with Evolved UTMS Terrestrial Radio Access (E-UTRA) using LTE, LTE-A, and/or LTE-B. It is contemplated that the communication system 100 may use multiple channel access operation, including such schemes as described above. Other radio technologies for implementing air interfaces include IEEE 802.11, 802.15, 802.16, CDMA2000, CDMA2000 1X, CDMA2000 EV-DO, IS-2000, IS-95, IS-856, GSM, EDGE, and GERAN. Of course, other multiple access schemes and wireless protocols may be utilized.

The RANs 120a-120b are in communication with the core network 130 to provide the EDs 110a-110c with various services such as voice, data, and other services. The RANs 120a-120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a-120b or EDs 110a-110c or both, and (ii) other networks (such as the PSTN 140, the internet 150, and the other networks 160).

The EDs 110a-110d communicate with one another over one or more sidelink (SL) air interfaces 190b, 190d using wireless communication links, e.g., radio frequency (RF), microwave, infrared (IR), etc. The SL air interfaces 190b, 190d may utilize any suitable radio access technology, and may be substantially similar to the air interfaces 190a, 190c over which the EDs 110a-110c communication with one or more of the base stations 170a-170b, or they may be substantially different. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the SL air interfaces 190b, 190d. In some embodiments, the SL air interfaces 180 may be, at least in part, implemented over unlicensed spectrum.

In addition, some or all of the EDs 110a-110d may include operation for communicating with different wireless networks over different wireless links using different wireless technologies and/or protocols. Instead of wireless communication (or in addition thereto), the EDs may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as internet protocol (IP), transmission control protocol (TCP) and user datagram protocol (UDP). EDs 110a-110d may be multimode devices capable of operation according to multiple radio access technologies, and incorporate multiple transceivers necessary to support multiple radio access technologies.

In some embodiments, the signal is transmitted from a terrestrial BS to the UE or transmitted from the UE directly to the terrestrial BS and in both cases the signal is not reflected by a RIS. However, the signal may be reflected by the obstacles and reflectors such as buildings, walls and furniture. In some embodiments, the signal is communicated between the UE and a non-terrestrial BS such as a satellite, a drone and a high altitude platform. In some embodiments, the signal is communicated between a relay and a UE or a relay and a BS or between two relays. In some embodiments, the signal is transmitted between two UEs. In some embodiments, one or multiple RIS are utilized to reflect the signal from a transmitter and a receiver, where any of the transmitter and receiver includes UEs, terrestrial or non-terrestrial BS, and relays.

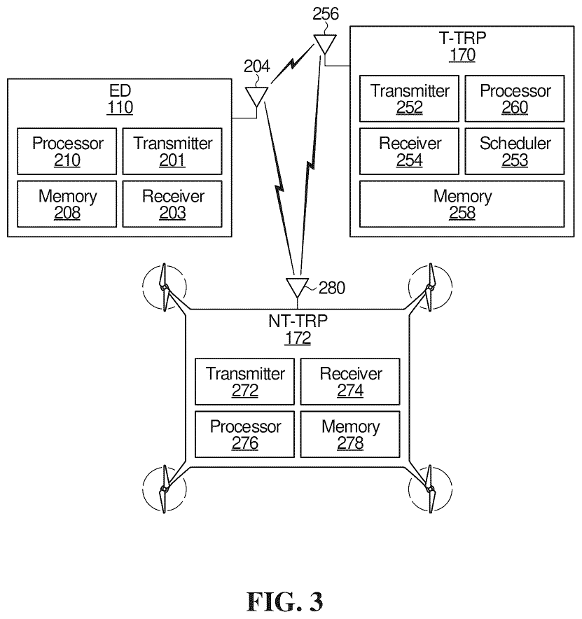

FIG. 3 illustrates another example of an ED 110 and network devices, including a base station 170 a, 170 b (at 170) and an NT-TRP 172. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g., communication module, modem, or chip) in the foregoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g., as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1 or 2). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g., by detecting and/or decoding the signaling). An example of signaling may be a reference signal transmitted by NT-TRP 172 and/or T-TRP 170. In some embodiments, the processor 210 implements the transmit beamforming and/or receive beamforming based on the indication of beam direction, e.g., beam angle information (BAI), received from T-TRP 170. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g., using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g., in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distributed unit (DU), positioning node, among other possibilities. The T-TRP 170 may be macro BSs, pico BSs, relay node, donor node, or the like, or combinations thereof. The T-TRP 170 may refer to the foregoing devices, or to apparatus (e.g., communication module, modem, or chip) in the foregoing devices. While the figures and accompanying description of example and embodiments of the disclosure generally use the terms AP, BS, and AP or BS, it is to be understood that such device could be any of the types described above.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g., through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g., multiple-input multiple-output (MIMO) precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g., initial access) and/or downlink synchronization, such as generating the content of synchronization signal blocks (SSBs), generating the system information, etc. In some embodiments, the processor 260 also generates the indication of beam direction, e.g., BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g., to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g., a physical downlink control channel (PDCCH), and static or semi-static higher layer signaling may be included in a packet transmitted in a data channel, e.g., in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g., in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g., MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g., BAI) received from T-TRP 170. In some embodiments, the processor 276 may generate signaling, e.g., to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g., in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g., through coordinated multipoint transmissions.

The T-TRP 170, the NT-TRP 172, and/or the ED 110 may include other components, but these have been omitted for the sake of clarity.

One or more steps of the embodiment methods provided herein may be performed by corresponding units or modules, according to FIG. 3. FIG. 3 illustrates units or modules in a device, such as in ED 110, in T-TRP 170, or in NT-TRP 172. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

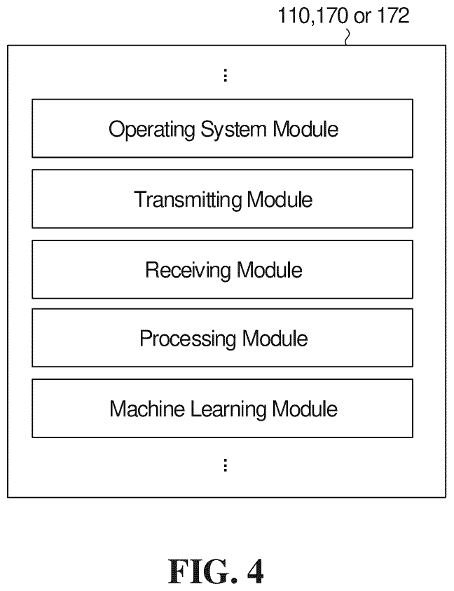

One or more steps of the embodiment methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

For future wireless networks, a number of the new devices could increase exponentially with diverse functionalities. Also, many new applications and new use cases in future wireless networks than existing in 5G may emerge with more diverse quality of service demands. These will result in new key performance indications (KPIs) for the future wireless network (for an example, 6G network) that can be extremely challenging, so the sensing technologies, and AI technologies, especially ML (deep learning) technologies, had been introduced to telecommunication for improving the system performance and efficiency.

AI/ML technologies applied communication including AI/ML communication in Physical layer and AI/ML communication in media access control (MAC) layer. For physical layer, the AI/ML communication may be useful to optimize the components design and improve the algorithm performance, like AI/ML on channel coding, channel modelling, channel estimation, channel decoding, modulation, demodulation, MIMO, waveform, multiple access, PHY element parameter optimization and update, beam forming & tracking and sensing & positioning, etc. For MAC layer, AI/ML communication may utilize the AI/ML capability with learning, prediction and make decisions to solve the complicated optimization problems with better strategy and optimal solution, for example to optimize the functionality in MAC, e.g., intelligent TRP management, intelligent beam management, intelligent channel resource allocation, intelligent power control, intelligent spectrum utilization, intelligent modulation and coding scheme (MCS), intelligent hybrid automatic repeat request (HARQ) strategy, intelligent transmit/receive (Tx/Rx) mode adaption, etc.

AI/ML architectures usually involve multiple nodes, which can be organized in two modes, i.e., centralized and distributed, both of which can be deployed in access network, core network, or an edge computing system or third-party network. The centralized training and computing architecture is restricted by huge communication overhead and strict user data privacy. Distributed training and computing architecture comprise several frameworks, e.g., distributed machine learning and federated learning. AI/ML architectures comprises intelligent controller which can perform as single agent or multi-agent, based on joint optimization or individual optimization. New protocol and signaling mechanism is needed so that the corresponding interface link can be personalized with customized parameters to meet particular requirements while minimizing signaling overhead and maximizing the whole system spectrum efficiency by personalized AI technologies.

Further terrestrial and non-terrestrial networks can enable a new range of services and applications such as earth monitoring, remote sensing, passive sensing and positioning, navigation, and tracking, autonomous delivery and mobility. Terrestrial networks based sensing and non-terrestrial network based sensing could provide intelligent context-aware networks to enhance the UE experience. For example, terrestrial networks based sensing and non-terrestrial network based sensing may involve opportunities for localization and sensing applications based on a new set of features and service capabilities. Applications such as THz imaging and spectroscopy have the potential to provide continuous, real-time physiological information via dynamic, non-invasive, contactless measurements for future digital health technologies. Simultaneous localization and mapping (SLAM) methods will not only enable advanced cross reality (XR) applications but also enhance the navigation of autonomous objects such as vehicles and drones. Further in terrestrial and non-terrestrial networks, the measured channel data and sensing and positioning data can be obtained by the large bandwidth, new spectrum, dense network and more line-of-sight (LOS) links. Based on these data, a radio environmental map can be drawn through AI/ML methods, where channel information is linked to its corresponding positioning or environmental information to provide an enhanced physical layer design based on this map.

Sensing coordinators are nodes in a network that can assist in the sensing operation. These nodes can be standalone nodes dedicated to just sensing operations or other nodes (for example TRP 170, ED 110, or core network node) doing the sensing operations in parallel with communication transmissions. A new protocol and signaling mechanism is needed so that the corresponding interface link can be performed with customized parameters to meet particular requirements while minimizing signaling overhead and maximizing the whole system spectrum efficiency.

AI/ML and sensing methods are data intensive. In order to involve AI/ML and sensing in wireless communications, more and more data are needed to be collected, stored, and exchanged. The characteristics of wireless data expand quite large ranges in multiple dimensions, e.g., from sub-6 GHz, millimeter to Terahertz carrier frequency, from space, outdoor to indoor scenario, and from text, voice to video. These data collecting, processing and usage operations are performed in a unified framework or a different framework.

Control information is referenced in some embodiments herein. Control information may sometimes instead be referred to as control signaling, or signaling. In some cases, control information may be dynamically communicated, e.g., in the physical layer in a control channel, such as in a physical uplink control channel (PUCCH) or physical uplink shared channel (PUSCH) or physical downlink control channel (PDCCH). An example of control information that is dynamically indicated is information sent in physical layer control signaling, e.g., uplink control information (UCI) sent in a PUCCH or PUSCH or downlink control information (DCI) sent in a PDCCH. A dynamic indication may be an indication in a lower layer, e.g., physical layer/layer 1 signaling, rather than in a higher-layer (e.g., rather than in RRC signaling or in a MAC CE). A semi-static indication may be an indication in semi-static signaling. Semi-static signaling, as used herein, may refer to signaling that is not dynamic, e.g., higher-layer signaling (such as RRC signaling), and/or a MAC CE. Dynamic signaling, as used herein, may refer to signaling that is dynamic, e.g., physical layer control signaling sent in the physical layer, such as DCI sent in a PDCCH or UCI sent in a PUCCH or PUSCH.

A change or rate or gradient of received power of a reference signal transmitted over one beam direction, which for simplicity may also be referred to in this disclosure as reference signal received power (RSRP) gradient, refers to a rate of change in the value of a RSRP with a change in a given variable, such as time or distance, in a specified direction. Applicant notes that the word gradient as used herein does not necessarily adhere to the typical mathematical definition.

UE beam RSRP reporting for multiple beams may use large overhead. This may especially be the case for UEs that have high mobility. Such a large use of overhead may result in time and frequency resources being wasted, or at least using resources that may otherwise be used for data communication or other more efficient uses. This additional overhead transmission may also cause UE energy to be depleted faster, which may be problematic as this affect UE battery usage. Aspects of the present application provide use of a message, for example a configuration information message, that includes beam RSRP gradient information that may enable efficient beam RSRP measurement and reporting. In some embodiments, use of beam RSRP gradient information may be used in methods for beam switching, beam failure detection and recovery procedures and beam refinement processes.

Some embodiments enable use of a beam RSRP gradient message. Some embodiments include a first device transmitting configuration information to a second device that enables the second device to efficiently use a beam RSRP gradient from the beam RSRP gradient message in various beam management procedures. In some embodiments, the first device may be a base station, or more generally a network side device, and the second device may be a UE, or more generally a terminal side device. In some embodiments, the first device may be a UE, or more generally a terminal side device, and the second device may be a base station, or more generally a network side device. In some embodiments, the first device and the second device may both be a UE, or more generally a terminal side device. In some embodiments, methods disclosed herein may help reduce beam RSRP measurement and reporting overhead, especially for high speed UEs.

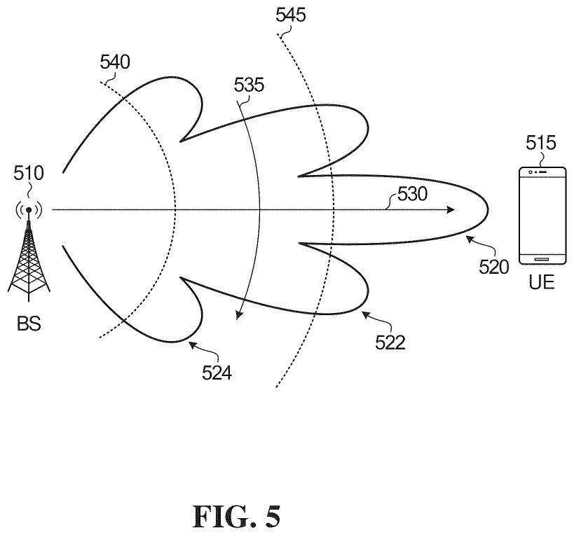

FIG. 5 illustrates an example of beam based communication between a base station (BS) 510 and a UE 515. A main beam 520 and several associated side lobes 522 and 524 are shown for a transmission from the BS 510 to the UE 515. The main beam 520 occurs on a line of sight (LoS) channel between the BS 510 to UE 515. The main beam is considered to be in a radial direction 530. The beam RSRP gradient information may be provided for various directions. FIG. 5 shows a first direction being the radial direction 530 and a second direction in a direction 535 perpendicular to the radial direction 530.

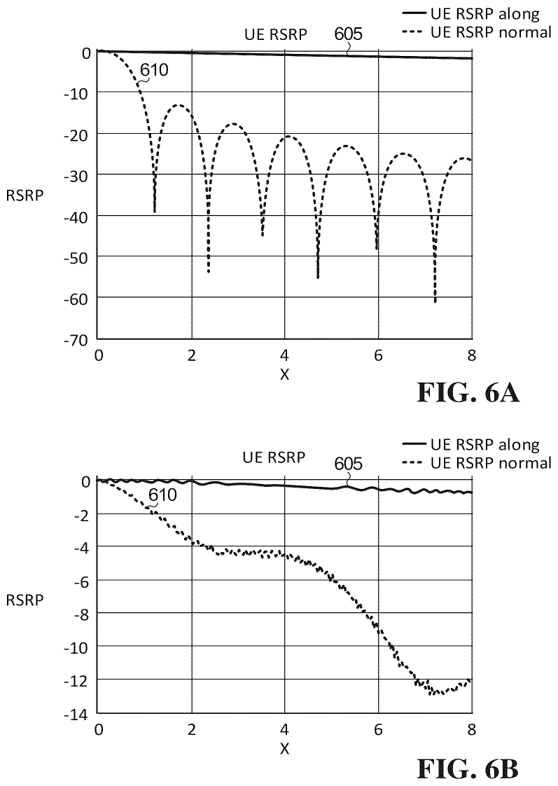

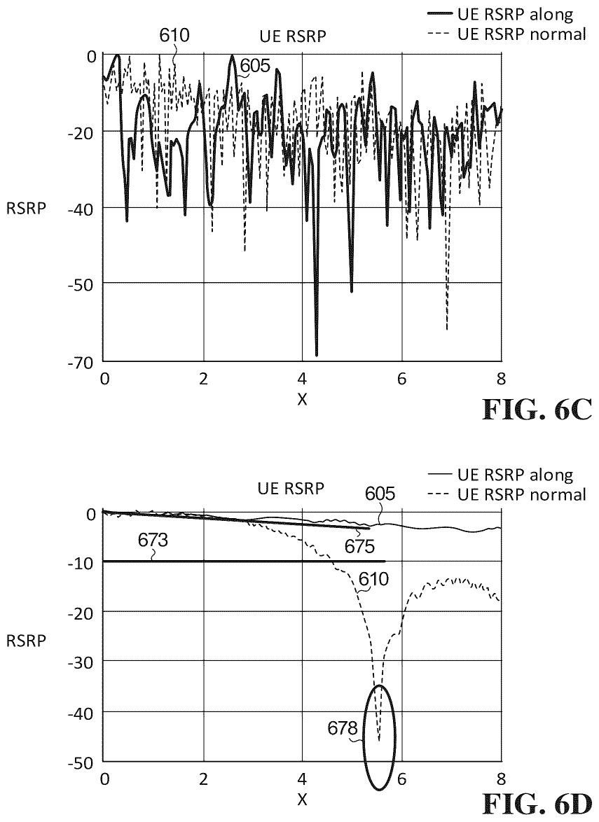

FIGS. 6A, 6B, 6C and 6D illustrate different scenarios of RSRP with respect to two different beam directionalities. For each figure, a channel has been simulated using a ray tracing program for multiple trajectory points in two directions. A first direction is a radial direction, as shown in FIG. 5, with respect to the channel path along the beam peak, i.e., an angle of arrival (AoA) for downlink or an angle of departure (AoD) in uplink at the UE. In FIGS. 6A, 6B, 6C and 6D this results in a plot 605 identified by “UE RSRP along”. A second direction is perpendicular to the radial direction, as shown in FIG. 5. The second direction is shown as a plot 610 identified by “UE RSRP normal”. FIGS. 6A, 6B, 6C and 6D each plot a distance versus a normalized RSRP in decibels (dB) from a transmission point of the reference signal. The plot is based on an assumption that the beam RSRP is measured using a best beam, in terms of highest received power, from a codebook for the initial transmission location. In FIGS. 6A and 6B, it can be seen that the plots corresponding to the radial direction 605, which correspond to the UE moving away from the BS with increasing distance, but still having the same AoD or AoA for a line of sight (LoS) case, present as an almost straight line with a decreasing RSRP value the further away from the initial transmission point. This decreasing of the RSRP may be associated with large scale channel fading, given that the UE remains at the beam peak along the path from angular domain perspective. FIG. 6A assumes a discrete Fourier transform (DFT) beam and the UE is relatively close to the BS. In FIG. 6B the beam is a wider chirp beam and the UE is further away from the BS. For example, the “UE RSRP normal” plot 610 in FIG. 6B may be at a second distance 545, as shown in FIG. 5, as compared to a first distance 540 as shown in FIG. 5, which may be the case for the “UE RSRP normal” plot 610 shown in FIG. 6A. The beam pattern changes as the distance between the UE and the BS changes. In addition, the beam pattern may be affected as a result of the beam pattern used by the BS.

FIG. 6C presents plots for “UE RSRP along” 605 and “UE RSRP normal” 610 for a channel resulting from many non-line of sight (NLoS) components caused by excessive scattering. Such a NLoS scenario may result in a lack of a clear pattern in either of the two directions.

There are multiple forms that may be used to express a beam RSRP gradient over distance or over time. For example, the beam RSRP gradient may be associated with a distance or over time over which the beam RSRP drops by a certain value, e.g., 10 dB. FIG. 6D illustrates an example with a radial direction plot 605 and a perpendicular to radial direction plot 610. The perpendicular to radial direction plot 610 is shown to drop by −10 dB 673 with respect to the power of the initial transmission point at a distance of approximately 4.6 units away from the transmission point. Such distance may be quantized and communicated to a device according to the configured RSRP drop. Accordingly, in this possible form of RSRP gradient communication, the device may receive a certain number of bits that corresponds to a certain distance upon which the device may expect a certain RSRP drop. The RSRP drop value, e.g., −10, in the example shown in FIG. 6D, may also be communicated, and it may also be quantized.

The bits representing the RSRP gradient may have special combinations associated with certain scenarios. In a first example, if the distance to the configured RSRP drop is too small, a certain combination of bits may be used, e.g., all “0” bits. In a second example, if the distance to the configured RSRP drop is too large, another certain combination of bits may be used, e.g., all “1” bits. In a third example, a certain set of bits may be used if the RSRP is increasing in a certain direction. The lowest possible overhead may be only one bit, where a first state, e.g., “0” means that the beam RSRP gradient is within a certain range, and a second state, e.g., “0”, means that the beam RSRP gradient is with another range. This type of use of bits may be useful to differentiate beams with normal degradation, e.g., FIGS. 6A and 6B, as compared to those beams with no pattern, e.g., FIG. 6C.

Because RSRP gradient is associated with a direction, there may be more than one communicated set of bits, each for a certain direction. In another scenario, the communicated RSRP gradient may be represented with a worst-case scenario among all directions. For example, only one value is communicated representing a shortest distance around the device to see such configured RSRP reduction, e.g., in FIG. 6D, that distance is largely dominated by direction 610.

Another example to represent the RSRP gradient associated with the radial direction plot 605 is to use a slope 675. Again, the slope value may be quantized, and some bit combinations may be used for specific scenarios. In some embodiments, the beam RSRP gradient may be represented using higher polynomials; e.g., a device receives one or more parameter so that the RSRP behavior can be approximated by a function such as a polynomial relating RSRP in dB domain to distance in metres domain or a polynomial relating RSRP in Watts domain to the distance in metres domain. One simple polynomial is a line, where a slope and constant can be used to describe the line. Higher degree polynomials may be used as well. The device may be configured to estimate one or more coefficients of the polynomial from its own measurements.

In some embodiments, the beam RSRP gradient may be represented as the distance to a first “null” 678, where the null may be defined by a large dB loss, for example −30 dB or higher. In some embodiments, the beam RSRP gradient may be represented as a distance over which a metric drops by a certain threshold, e.g., distance in which a reference signal received quality (RSRQ) drops by a predetermined value.

In some embodiments, when it may be supported that a network, or network side device, is configured to indicate to a terminal side device, such as a UE, at least one of an expected AoD or AoA for a given reference signal, the network or network side device may indicate to the UE an expected RSRP rate of change, or gradient, along or perpendicular to the indicated at least one of expected AoA or AoD, or relative directions with regard to the indicated at least one of expected AoA or AoD, for an SSB or CSI-RS resource. As such, it should be understood that aspects of the present disclosure may be used in conjunction with other existing methods. For example, a network, or network side device, is configured to indicate to a terminal side device, such as a UE, at least one of an expected AoD or AoA for a given positioning reference signal (PRS).

The aforementioned ways for communicating the RSRP gradient are examples provided herein to show that various methods may be used and that other methods may also be used. These methods are not precluded from this proposal.

In some embodiments, the beam RSRP gradient may not be able to be represented by because there is no obvious beam pattern, for example as shown in FIG. 6C.

In some embodiments, the beam RSRP gradient includes information that is associated with how the beam RSRP changes over distance. In some embodiments, when the UE is mobile and the UE velocity is known, the beam RSRP gradient may be associated with change over time. When the UE is mobile and beam tracking is enabled and the beam changes over time, the beam RSRP may be associated with the beam RSRP gradient when both the UE and beam changes are considered. For example, the RSRP may be estimated based on a change rate or gradient in time and knowing a duration of time over which a UE is traveling. In some embodiments, the beam RSRP gradient is based on the expected value of the beam RSRP, because the beam RSRP may change due to reasons such as UE thermal noise, small scale channel fading, etc.

The beam RSRP gradient information may be communicated from the BS to the UE in any of the above-mentioned forms, or a combination thereof. It may also be communicated in other forms. In some embodiments, the beam RSRP gradient information may be for the communication beam. In some embodiments, the beam RSRP gradient information may be for beams other than the communication beam. For example, the beam RSRP gradient information may be for beams that may potentially be used for beam switching, beams that may potentially be used for potential beam failure recovery, or beams from other BSs that may potentially be used for handover (HO).

In some embodiments, the message including the beam RSRP gradient information from the BS to the UE may be periodic. In some embodiments, the message including the beam RSRP gradient information from the BS may be aperiodic. For example, the BS may send beam RSRP gradient information whenever the beam is updated. In some embodiments, the message including the beam RSRP gradient information from the BS may be triggered by another event. For example, the BS may send beam RSRP gradient information when triggered by the UE, e.g., the UE realizes a large deviation between measured beam RSRP and what the expected beam RSRP should be based on the beam RSRP gradient information. Another example of an event that may trigger the sending of beam RSRP gradient information is that the UE requests updated configuration information. While communication of the beam RSRP gradient information is expressed with regard to transmission by the BS for a downlink scenario, it is to be understood that in an uplink or sidelink scenario, the beam RSRP gradient information may be transmitted by the UE to a BS or to another UE.

In some embodiments, the beam RSRP gradient information describes how the beam RSRP changes over distance, i.e., the distance from the transmission point. In some embodiments, the RSRP gradient information may be expressed in the form of a three-dimensional (3D) vector. The three dimensions may correspond to RSRP gradient information for each of three directions. One direction corresponding to a first dimension of the 3D vector consists of the direction along the AoA, when considered LoS from the BS to the UE. An example of this may be shown as direction 530 in FIG. 5. The direction along the AoA is associated with large-scale fading, where the UE angularly is still at beam peak. Such direction may be estimated by the UE when the UE is equipped with multiple beams. The width of the UE beams (narrow or wide) may affect the accuracy of at least one of knowledge or estimating the angular direction.

A second direction corresponding to a second dimension of the 3D vector may be the horizontal direction that is perpendicular to the direction along the AoA. An example of such a direction is shown as direction 535 in FIG. 5. This may correspond to a direction normal to the beam angular direction in an orientation parallel to the surface of the Earth.

A third direction corresponding to a third dimension of the 3D vector may be with respect to elevation. This may be considered a vertical direction that is perpendicular to the direction along the AoA. So this may be considered similar to the direction 535 shown in FIG. 5, but perpendicular to the plane define by the directions 530 and 535. This may correspond to a direction normal to the beam angular direction in an orientation perpendicular to the surface of the Earth.

It should be understood that even when represented using a 3D vector, presenting the beam RSRP gradient information in each direction may not be equally important. For example, a UE that is in possession of a pedestrian may be more interested in the direction associated with the beam sidelobes, i.e., the horizontal direction that is perpendicular to the direction along the AoA, as the most important direction. In the UE in possession of a pedestrian scenario, the direction associated with large scale fading may be of less importance as the gradient may not change considerably in the local area the pedestrian moves toward or away from the BS and the elevation may be of no importance if the UE is not changing its elevation significantly. However, in the scenario of a UE in possession of a person in a building, elevation may be particularly important when the UE in possession of the person is using stairs or an elevator. Since not all directions are equally important, the update frequency may differ from one direction to another. For example, if the direction related to elevation does not need to be updated as frequently, a 3D update may be sent less frequently and 2D vector beam RSRP gradient information may be sent more frequently for two directions excluding the elevation direction.

Furthermore, while a 3D vector is on example of how beam RSRP gradient information may be sent from the base station to the UE, it is to be understood that the information may be sent in alternative manners. For example, a 2D vector may be used when beam RSRP gradient information for two directions are sent, or if beam RSRP gradient information is provided for only a single direction, a scalar may be used. In some embodiments, a combination of two or more of the different types of vectors could be used.

While the examples described above make particular reference to a set of three particular directions, it should be understood that the beam RSRP gradient information may also be presented in other directions than the three directions discussed above. In one example, the beam RSRP gradient information may be presented for a particular UE line of movement. In another example, the beam RSRP gradient information may be presented according to a set of directions that the BS understands and the UE may translate the set of directions to UE local coordinates. For example, the BS directions or the UE local coordinates may be expressed as cardinal directions such as north, south, east, and west. Other direction sets are also possible.

In some embodiments, once the BS communicates the beam RSRP gradient information to the UE for one or more beams, the UE may use the beam RSRP gradient information for one or more beam management methods. When the beam RSRP gradient information is for the communication beam, the UE may be instructed to change, or the UE may determine on its own, one or more of the measurement periodicity or reporting periodicity according to the communicated gradient.

For a given communication beam pair, the UE may perform periodic measurements (e.g., RSRP/Q, SINR, SNR, power) according to beam gradient. The periodicity of the measurements may vary.

In some embodiments, the beam RSRP gradient information may be used to update the parameters of at least one of layer 1 (L1) or layer 3 (L3) RSRP filtering. L3 filtering is a type of filtering in which measurement data is filtered when fed back to another device. The L3 filtering process uses previous measurement information to obtain a somewhat smoothed or weighted result based on previous measurements as well as the current measurement. The beam RSRP gradient information may have an effect on one or more filtering coefficient in a LS filtering equation that in turn affects the overall filtering process.

In some embodiments, when the UE uses the RSRP measurement for the current location of the UE and uses the RSRP gradient information, such as the RSRP gradient slope to estimate the beam RSRP, the UE may feedback the difference between the estimated beam RSRP and the measured beam RSRP. In such a scenario, a number of bits associated with differential beam RSRP feedback may be lower because the difference between the estimated beam RSRP and the measured beam RSRP should not be large as the absolute value of the measured RSRP, thereby reducing the feedback overhead. When the difference is large, thereby requiring a larger number of bits, this may indicate a problem with the beam, for example a beam blockage resulting in a lower or loss of signal strength. Accordingly, when the difference is large, an exact RSRP value may not be particularly important, rather the signalling for possible problems that results ins beam update or beam failure recovery.

In some embodiments, the UE may use the estimated RSRP and the measured beam RSRP to initiate a UE beam refinement procedure to improve beam pair alignment. In some embodiments, UE beam refinement may be performed by detecting UE orientation change based on a difference between the estimate RSRP and measured RSRP and then updating the UE beam according to UE movement compared to beam gradients (e.g., with radial movements of a device there may be no significant difference between the estimate RSRP and measured RSRP, however when angular movements are detected, an update may be warranted).

In some embodiments, there may be a correspondence between changes in the BS beam RSRP and changes that may therefore result in the UE beam. For example, if a UE is communicating with the BS via a given beam and the UE is LoS, very small changes in beam RSRP may indicate that the UE is still at the BS beam peak and no UE beam refinement is needed. In a particular example, the UE is moving radially towards or away from the BS, but keeping the same angular relation, i.e., as shown in direction 530 in FIG. 5. However, if the beam RSRP drops significantly, the BS and UE beam may both be losing alignment. The UE may be moving in an angular direction away from the BS beam peak, such as in a direction 535 as shown in FIG. 5. In the latter case when the beam RSRP drops significantly, this may cause the BS to initiate beam switching or to update the BS beam using a beam tracking procedure or may cause the UE to initiate a UE beam refinement procedure. In some embodiments, a UE may sense an orientation change of the UE, by using a gyroscope or accelerometer sensor in the UE, and may confirm such an orientation change by comparing the estimated and measured beam RSRP. A change in the orientation of the UE may cause beam misalignment between the BS and UE if, for instance, the beam of the UE that was aligned with the BS beam is pointed in a different direction after the change in orientation and is no longer aligned with the BS beam.

The UE may also use the beam RSRP gradient information for other beam management methods. In some embodiments, the UE may use the estimated RSRP based on the RSRP gradient information and the measured beam RSRP to start a UE-initiated beam switching method. This may occur when the difference between the estimated RSRP and the measured beam RSRP is large. The definition of “large” may be based on a threshold value, that when the difference exceeds this threshold value, the beam switching method is initiated.

The UE may also use the estimated beam RSRP to enable faster assessment of a communication beam during beam failure detection. In some embodiments, the UE may use the measured RSRP and the estimated beam RSRP, in addition to some configured parameters, to reduce a number of time slots used for beam assessment. For example, one parameter may be a number of slots after which a failure may be declared if the differential between estimated and measured continues to be large. Another example may be a size of a large differential value that may indicate a failure. When the differential is large, less slots may be indicated for declaring a failure and when the differential is small, more slots may be indicated for declaring a failure to ensure that when a failure is declared there is confidence there is indeed a failure. When the communication beam is considered a failed beam, the UE may use the RSRP gradient information to determine another beam that may be more likely to be a successful communication beam as part of beam failure recovery. In one example, the UE may select the beam with the highest expected beam RSRP, which may be estimated based on previous measurements and RSRP gradient information. In another example, the UE may select a beam with reasonable RSRP for proper communication, but also a beam with small RSRP gradient. In some embodiments, the beam RSRP gradient information may help the UE in setting the transmit power during beam failure recovery, for example the UL transmit power.

In some embodiments, the UE may only be provided with partial RSRP gradient information. An example of partial information may be related to beam RSRP gradient slope. When the UE receives partial RSRP gradient information, the UE may still be able to enhance some beam management methods. For example, if the UE is provided with information indicating a distance at which the beam RSRP drops by a certain value, such information may not provide how the beam RSRP behaves between the current UE location and that indicated distance. However, if the UE realizes a power drop that is larger than that certain value before the indicated distance, the UE may be able to detect a signal blockage faster than if such a power drop was not realized based on the partial RSRP gradient information, even if the UE does not know exactly the expected beam RSRP at that location. In general, partial RSRP gradient information may still be used to better assess the communicating beam.

When the BS communicates with the UE by providing the beam RSRP gradient information, the UE may be able to determine if such a beam may be used for communication for a long time or not. A beam with no recognizable pattern, such as shown in FIG. 6C, may indicate severe RSRP variations, while a beam with a larger distance to a certain threshold may be better than a beam with a smaller distance to the same threshold. Accordingly, not only may the UE be able to determine how the beam RSRP changes, but the UE may also be able to infer a quality of the beam. In some embodiments, the UE may be configured to perform beam selection and reporting based on a prioritization of beam RSRP gradient information. For example, beam RSRP gradient information may be used for prioritizing beams based on a UE being better served with a beam of lower RSRP, but with a smaller RSRP gradient than a beam with higher RSRP that has a steeper RSRP gradient. When one or more beams are possible for communication, the choice of which beam to select may rely on the beam RSRP gradient that would appear to result in robust performance for a longer time duration.

Aspects of the proposed invention relate to beam RSRP gradient communication. As such, use of RSRP gradient information may be applied for many types of beam-based communication. Aspects of the proposed disclosure may be applied for frequency division duplex (FDD) or time division duplex (TDD) systems.

As indicated above, while a focus of the described examples is provided with reference to a downlink measurement scenario between BS and UE, it should be understood that the concepts described herein may also apply to uplink measurement scenarios and sidelink measurement scenarios, as well as other wireless links, such as non-terrestrial, satellite, and WiFi™.

In some embodiments, the BS communicates one or more parameters that are associated with the gradient of received power of a reference signal transmitted over one beam direction in the form of beam RSRP gradient information. The BS may communicate one or more parameters of a set of parameters that correspond to one or more directions for which the beam RSRP gradient information is of interest. In some embodiments, the BS may communicate one or more set of parameters regarding one or more directions for one or more beams. If the BS is able to communicate more than one form of information regarding the beam RSRP gradient, the BS may inform the UE regarding which form is being used. Examples of the form of the beam RSRP gradient information may include, but are not limited to, a distance over which the beam RSRP drops by a certain value, a slope of a line along a certain distance, a distance to a first null defined by a large loss, a distance over which a metric drops by a certain threshold.

The BS may send partial information to the UE, e.g., beam RSRP gradient information for a selected direction or a select few directions, but not all directions, or partial RSRP gradient information that enables the UE to estimate RSRP that may be useful to the UE. In some embodiments, the BS may send the beam RSRP gradient information with different periodicity, granularity and dynamic range depending on the direction. For example, the BS may send information regarding the elevation direction less often than other directions. In some embodiments, the UE may be configured to use the same beam RSRP gradient information until new updated beam RSRP gradient information is received. In some embodiments, the UE may be configured or informed about how beam RSRP gradient information associated with a previously used beam may be used to determine a new beam RSRP gradient.

In some embodiments, when the base station configures the UE with beam RSRP gradient information, the UE may use such information to enhance various beam management methods resulting in fewer delays, fewer measurements and less feedback overhead being used.

In some embodiments, the BS configures the UE regarding how to use beam RSRP gradient information to enhance various beam management methods. In one example, the BS may configure the UE with regard to frequency of measurement and reporting according to the beam RSRP gradient information. In some embodiments, the BS may configure the UE with regard to how to report feedback in a differential form by comparing the estimated beam RSRP, which is determined based on the beam RSRP gradient information, and the measured beam RSRP. In some embodiments, the BS may configure the UE with regard to how to estimate the beam RSRP using the communicated beam RSRP gradient information and UE measurements. In some embodiments, the BS may configure the UE with regard to how and when to initiate UE beam refinement based on one or more parameters in the beam RSRP gradient information communicated from the BS and the measured beam RSRP. The BS may configure the UE regarding how and upon which criteria to start UE-initiated beam switching based on the parameters sent by the BS and the measured beam RSRP. The BS may configure the UE regarding how to use the parameters associated with beam RSRP gradient and the measured beam RSRP gradient to faster assess beams during beam failure detection and recovery procedures. The BS may configure the UE regarding how to use the parameters associated with beam RSRP gradient of different beams to determine which is the best beam for possible beam failure recovery and associated UL transmit power for that beam.

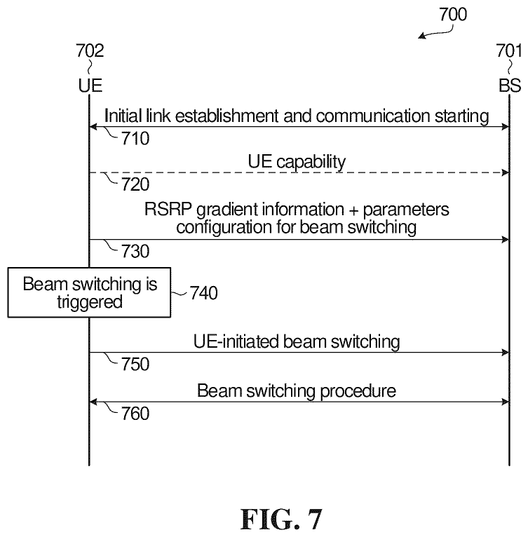

FIG. 7 illustrates a signal flow diagram for signaling between a base station and a UE illustrating an example process for supporting network communication, in accordance with embodiments of the present disclosure.

The example process 700 is comprised of steps 710, 720, 730, 740, 750 and 760. Some of the steps may be optional. It should be understood that, in some embodiments, the order of one or more steps 710, 720, 730, 740, 750 and 760 may be changed.

At step 710, a link is established between a BS 701 and a UE 702. This may involve initial access by the UE 702 or other processes that generate the link between the two devices. At step 720, the UE 702 may optionally transmit UE capability information, e.g., through radio resource control (RRC) signaling, to the BS 701 that enables the BS 701 to determine which form of beam RSRP gradient information and which particular parameters the BS 701 may provide to the UE 702 to enable measurement of RSRP, estimation of RSRP, feedback of RSRP as well as configuration for beam switching. In some embodiments, the UE capability information may include an indication of whether the UE has access to at least one of a compass, a gyroscope, an accelerometer, or any other sensors. In some embodiments, the UE capability information may include an indication of precision and accuracy of coordination measurement, as well as whether directional information for the UE 702 should be expressed in cardinal or directions specific to the UE directionality.

At step 730, the BS 701 transmits to the UE 702 beam RSRP gradient information and configuration information parameters, e.g., using RRC, that may be used by the UE 702 as part of UE-initiated beam switching. The UE 702 monitors conditions related to beam switching at some configured interval. Conditions that may indicate that beam switching should occur may include a comparison between the measured RSRP and an estimated RSRP based on provided beam RSRP gradient information received at step 730. If and when the conditions are satisfied, the UE 702 is triggered at step 740 to inform the BS 701. In some embodiments, the UE 702 may suggest alternative beams that may be good beams to switch to based on information received in the beam RSRP gradient information, such as when the beam RSRP gradient information includes beam RSRP gradient information for beams other than just the communication beam At step 750, the UE 702 informs the BS 701 that beam switching should be initiated, e.g., using RRC, media access control - control element (MAC-CE), or uplink control information (UCI) signaling. At step 760, the beam switching procedure is performed. In some embodiments, even without the BS 701 receiving UE-initiated beam switching information in step 750, the BS 701 may be able to initiate beam switching based on information that the BS 701 has received from the UE 702 in step 730.

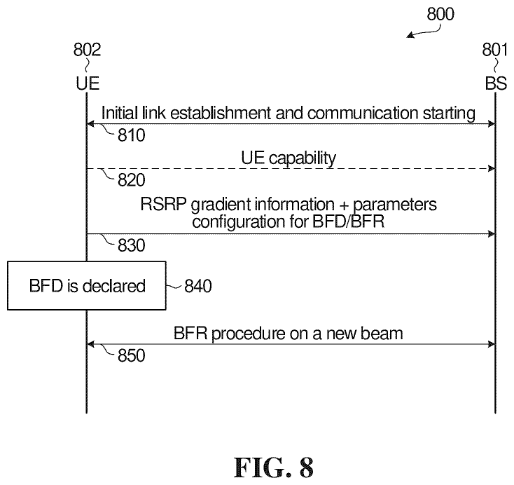

FIG. 8 illustrates a signal flow diagram for signaling between a base station and a UE illustrating an example process for supporting network communication, in accordance with embodiments of the present disclosure.

The example process 800 is comprised of steps 810, 820, 830, 840 and 850. Some of the steps may be optional. It should be understood that, in some embodiments, the order of one or more steps 810, 820, 830, 840 and 850 may be changed.

At step 810, a link is established between a BS 801 and a UE 802. This may involve initial access by the UE 802 or other processes that generate the link between the two devices. At step 820, e.g., using RRC signaling, the UE 802 may optionally transmit UE capability information to the BS 801 that enables the BS 801 to determine which form of beam RSRP gradient information and which particular parameters the BS 801 may provide to the UE 802 to enable measurement of RSRP, estimation of RSRP, feedback of RSRP as well as configuration for beam failure detection and beam failure recovery. In some embodiments, the UE capability information may include an indication of whether the UE 802 has access to at least one of a compass, a gyroscope, an accelerometer, or any other sensors. In some embodiments, the UE capability information may include an indication of precision and accuracy of coordination measurement, as well as whether directional information for the UE 802 should be expressed in cardinal or directions specific to the UE directionality.

At step 830, e.g., using RRC signaling, the BS 801 transmits to the UE 802 beam RSRP gradient information and configuration information parameters that may be used by the UE 802 as part of beam failure detection (BFD) and beam failure recovery (BFR). The UE 802 monitors the conditions related to BFD at some configured interval. Conditions that may indicate that beam failure has occurred may include a comparison between the measured RSRP and an estimated RSRP based on provided beam RSRP gradient information received at step 830. If and when the conditions are satisfied, the UE 802 is triggered at step 840 to declare BFD. At step 850, the BFR procedure is performed.

While FIGS. 7 and 8 describe examples with reference to a downlink measurement scenario that aid in beam switching and BFD and BFR between BS and UE, it should be understood that the concepts described herein may also apply to uplink measurement scenarios and sidelink measurement scenarios.

In some embodiments, when the UE is provided with information related to beam RSRP gradient, the BS may configure the UE to efficiently use such information, in addition to measurements made by the UE to enhance various beam procedures. Such configuration may result in a reduction in measurement and feedback overhead, faster beam failure detection and beam failure recovery, and more efficient UE-initiated beam switching.

The embodiments described above are in the context of UEs communicating with a BS. However, more generally, devices that wirelessly communicate with each other over time-frequency resources need not necessarily be one or more UEs communicating with a BS. For example, two or more UEs may wirelessly communicate with each other over a sidelink using device-to-device (D2D) communication. As another example, two network devices (e.g., a terrestrial base station and a non-terrestrial base station, such as a drone) may wirelessly communicate with each other over a backhaul link. Embodiments are not limited to uplink and/or downlink communication. For example, in the embodiments above, the BS may be substituted with another device, such as a node in the network or a UE. The uplink/downlink communication may instead be sidelink communication.

Examples of devices (e.g., UE, BS) to perform the various methods described herein are also disclosed.

For example, a device may include a memory to store processor-executable instructions, and a processor to execute the processor-executable instructions. When the processor executes the processor-executable instructions, the processor may be caused to perform the method steps of one or more of the devices as described herein, e.g., in relation to FIGS. 1 to 4 and 17. For example, the processor may cause the device to communicate over an air interface in a mode of operation by implementing operations consistent with that mode of operation, e.g., performing necessary measurements and generating content from those measurements, as configured for the mode of operation, preparing uplink transmissions and processing downlink transmissions, e.g., encoding, decoding, etc., and configuring and/or instructing transmission/reception on RF chain(s) and antenna(s).

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the figures or all of the portions schematically shown in the figures. Moreover, selected features of one example embodiment may be combined with selected features of other example embodiments.

While this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

1. A method comprising:
receiving, by an apparatus, configuration information, the configuration information indicating one or more parameters associated with a rate of change of received power of a reference signal transmitted over a beam, wherein the rate of change indicates the change of the received power in at least one of:
a specific direction;
one or more directions; or
per time slot.

2. The method of claim 1, wherein the rate of change of the received power of the reference signal transmitted over one beam direction is a rate of change information for at least one of:
a direction normal to a beam angular direction in an orientation parallel to a surface of the Earth;
a direction along the beam angular direction; or
a direction normal to the beam angular direction in an orientation perpendicular to the surface of the Earth.

3. The method of claim 1, wherein when the one or more parameters associated with the rate of change of the received power of the reference signal over one beam direction are provided in any of a plurality of different forms, the method further comprising:
receiving an indication of a form of the plurality of different forms that is used to provide information regarding the rate of change of the received power of the reference signal transmitted over one beam direction.

4. The method of claim 1, wherein when the one or more directions are at least two directions, the configuration information is received with at least one of different periodicities, different granularities, or different dynamic ranges for the at least two directions of the one or more directions.

5. The method of claim 1, wherein the one or more parameters include at least one of:
the rate of change of the received power of the reference signal expressed in terms of a distance from a reference location; or
the rate of change of the received power of the reference signal expressed in terms of a time from a reference time.

6. A method comprising:
transmitting, by an apparatus, configuration information, the configuration information indicating one or more parameters associated with a rate of change of received power of a reference signal transmitted over a beam, wherein the rate of change indicates the change of the received power in at least one of:
a specific direction;
one or more directions; or
per time slot.

7. The method of claim 6, wherein the rate of change of the received power of the reference signal transmitted over one beam direction is a rate of change information for at least one of:
a direction normal to a beam angular direction in an orientation parallel to a surface of the Earth;
a direction along the beam angular direction; or
a direction normal to the beam angular direction in an orientation perpendicular to the surface of the Earth.

8. The method of claim 6, wherein when the one or more parameters associated with the rate of change of the received power of the reference signal over one beam direction are provided in any of a plurality of different forms, the method further comprising:
transmitting an indication of a form of the plurality of different forms that is used to provide information regarding the rate of change of the received power of the reference signal transmitted over one beam direction.

9. The method of claim 6, wherein when the one or more directions are at least two directions, the configuration information is transmitted with at least one of different periodicities, different granularities, or different dynamic ranges for the at least two directions of the one or more directions.

10. The method of claim 6, wherein the one or more parameters include at least one of:
the rate of change of the received power of the reference signal expressed in terms of a distance from a reference location; or
the rate of change of the received power of the reference signal expressed in terms of a time from a reference time.

11. An apparatus, comprising:
at least one processor coupled with at least one memory storing one or more instructions that are capable of being run on the at least one processor, and when the one or more instructions are run, the apparatus is enabled to:
receive configuration information, the configuration information indicating one or more parameters associated with a rate of change of received power of a reference signal transmitted over a beam, wherein the rate of change indicates the change of the received power in at least one of:
a specific direction;
one or more directions; or
per time slot.

12. The apparatus of claim 11, wherein the rate of change of the received power of the reference signal transmitted over one beam direction isa rate of change information for at least one of:
a direction normal to a beam angular direction in an orientation parallel to a surface of the Earth;
a direction along the beam angular direction; or
a direction normal to the beam angular direction in an orientation perpendicular to the surface of the Earth.

13. The apparatus of claim 11, wherein when the one or more parameters associated with the rate of change of the received power of the reference signal over one beam direction are provided in any of a plurality of different forms, the apparatus is further enabled to:
receive an indication of a form of the plurality of different forms that is used to provide information regarding the rate of change of the received power of the reference signal transmitted over one beam direction.

14. The apparatus of claim 11, wherein when the one or more directions are at least two directions, the configuration information is received with at least one of different periodicities, different granularities, or different dynamic ranges for the at least two directions of the one or more directions.

15. The apparatus of claim 11, wherein the one or more parameters include at least one of:
the rate of change of the received power of the reference signal expressed in terms of a distance from a reference location; or
the rate of change of the received power of the reference signal expressed in terms of a time from a reference time.

16. An apparatus, comprising:
at least one processor coupled with at least one memory storing one or more instructions that are capable of being run on the at least one processor, and when the one or more instructions are run, the apparatus is enabled to:
transmit configuration information, the configuration information indicating one or more parameters associated with a rate of change of received power of a reference signal transmitted over a beam, wherein the rate of change indicates the change of the received power in at least one of:
a specific direction;
one or more directions; or
per time slot.

17. The apparatus of claim 16, wherein the rate of change of the received power of the reference signal transmitted over one beam direction is a rate of change information for at least one of:
a direction normal to a beam angular direction in an orientation parallel to a surface of the Earth;
a direction along the beam angular direction; or
a direction normal to the beam angular direction in an orientation perpendicular to the surface of the Earth.

18. The apparatus of claim 16, wherein when the one or more parameters associated with the rate of change of the received power of the reference signal over one beam direction are provided in any of a plurality of different forms, the apparatus is further enabled to:
transmit an indication of a form of the plurality of different forms that is used to provide information regarding the rate of change of the received power of the reference signal transmitted over one beam direction.

19. The apparatus of claim 16, wherein when the one or more directions are at least two directions, the configuration information is transmitted with at least one of different periodicities, different granularities, or different dynamic ranges for the at least two directions of the one or more directions.

20. The apparatus of claim 16, wherein the one or more parameters include at least one of:
the rate of change of the received power of the reference signal expressed in terms of a distance from a reference location; or
the rate of change of the received power of the reference signal expressed in terms of a time from a reference time.
